(19) United States
(12) Patent Application Publication
(10) Pub. No.: US 2009/0024746 A1
(43) Pub. Date: Jan. 22, 2009

(54) Method and apparatus for host controller operations over a network

(76) Inventor: Eric Welch, Berkeley, CA (US)

Correspondence Address: REED SMITH, LLP, TWO EMBARCADERO CENTER, SUITE 2000, SAN FRANCISCO, CA, 94111, US

(21) Appl. No.: 10/671,896

(22) Filed: Sep. 25, 2003

(51) Int. Cl. G06F 15/173; G06F 13/00; G06F 3/00; H04L 9/32

(52) U.S. Cl. 709/228; 710/305; 726/5; 710/16

(57) ABSTRACT

A remote host controller includes USB ports and a network interface. A processing device in the remote host controller supports an IP stack in communication with a network and drivers in communication with a Universal Serial Bus attached to the USB ports. The remote host controller registers with hosts on the network. Registered hosts are sent communications regarding attachment and detachment of peripheral devices to/from the remote host controller. The registered hosts are selectively configured to be able to communicate with one or more of the peripheral devices. Communications between applications and the peripherals are transparent in that they operate as if directly attached to a USB port on the host computer.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to network devices, and amongst other things to a method of controlling a network attached device from a remote computer. The invention is more particularly related to a remote host controller attached to a network and accessible on an exclusive basis to individual ones of multiple computing devices remotely located but in communication with the network.

2. Discussion of Background

The Universal Serial Bus (USB) Specification, Revision 2.0 Apr. 27, 2000, the contents of which are incorporated herein by reference in their entirety, describes a modern scheme for connecting all manner of different peripherals to a desktop or mobile computer. The specification includes an electrical signaling system, communication protocols and device function abstractions. The original motivation for the creation of USB was ease-of-use, where USB offered self-configuring peripherals and plug-and-play performance; and port expansion whereby new and different types of peripherals could be supported by one serial bus scheme. To quote from Section 1.1 Motivation: “Thus, USB continues to be the answer to connectivity for the PC architecture. It is a fast, bi-directional, isochronous, low-cost, dynamically attachable serial interface that is consistent with the requirements of the PC platform of today and tomorrow.”

Universal Serial Bus (USB) is a standard peripheral interface for attaching personal computers to a wide variety of devices: e.g., digital cameras, external disk drives, telephone lines, monitors, modems, mice, Ethernet ports, printers, scanners, game controllers, keyboards, etc. The universal serial bus (USB) standard has allowed a significant improvement in the connection of these and other peripheral devices to a host computer by allowing for multiple peripheral devices to be connected to the host computer through a USB host controller that is connected to that host via a PCI or other local directly connected bus. Essentially any device that communicates with a host computer may be configured to do so via a USB interface, so long as the device's bandwidth requirements are within a range that is compatible with the USB version implemented on the host computer.

Also described in the above noted specification is the USB Host Controller. It has the responsibility for managing the electrical and logical communication between the USB Host and USB Device. USB Host Controllers are typically attached to the host computer via some type of local bus, most commonly PCI.

In accordance with current USB standards, all USB attached devices connect to a personal computer through a single connector type using a tiered-star topology. As shown in FIG. 1, peripheral devices 110 are connected to a host computer 100, usually a PC (MAC and/or IBM compatible), through a USB host controller 120 in a tiered star topology. Typically, the USB host controller 120 is at the center of the star topology with the host computer 100 on the upper tier and the peripheral devices 110 on the lower tier. The USB host controller 120 connects to a PCI (or equivalent) bus 130 of the host computer 100. The USB host controller 120 connects to the peripheral devices 110 via a root hub 140. The host computer 100 includes a microprocessor 150, and a memory having programs including applications, drivers and other software components executed on the microprocessor as needed to control various attached peripherals and internal functions of the host computer, and perform processing as required by any user applications. An Ethernet card 170, provides an Ethernet port to connect to a network 180.

The host controller provides the interface between the USB devices and the host computer. The host controller controls all accesses to USB resources and monitors the bus's topology. Additional USB hubs may be utilized to provide USB attachment points for additional USB devices.

Arbitration between different devices and the host on a USB bus is handled in a master/slave arrangement where the host is the master. All device communication on the bus takes place when the host controller initiates a transaction that will continue for a given device until it completes, an error occurs or it is cancelled by the host. An example of these transactions is when the host wishes to read data from a device it posts a ‘read’ transaction with the Host Controller, which continues until completed as above.

The growth of networks, such as Ethernet, has exploded over the past decade. With the growth in networks is a simultaneous growth in the need for network compatible peripheral devices such as printers, scanners, fax machines, etc. Current prices on wireless versions of access points, routers, and modems is falling very low, making networks more convenient and further fueling the demand for more network compatible type devices.

### SUMMARY OF THE INVENTION

The present inventor has realized the need to access standard computer peripherals from one or more remotely located computers over a communications network. The present invention provides a stand alone host controller device coupled to a network and configured to receive command and data information over the network from an assigned host computer, and send operational messages/data from an attached USB device to the assigned host. The present invention includes a device that operates as a USB Host Controller that is attached to one or more host computing devices via an IP network instead of a PCI bus. In this document, “host controller” generally, and specifically any of “stand alone host controller,” “NHCI (Network Host Controller Interface)”, “NHCI Device,” and “NHCI” refer to the present invention. “Host,” “Host Client,” or “remote computer” refer generally to those devices that can connect to the NHCI and receive device control services from it and access to the remote devices connected to it.

In one embodiment, the present invention provides a stand alone host controller, comprising, an interface, a bus and at least one external port coupled to the bus, and a processor coupled to the bus and the network interface and configured to process device related communications received from the network interface to prepare messages and place the prepared messages on the bus. Preferably the interface is a network interface and the bus is a Universal Serial Bus (USB).

In another embodiment, the present invention provides facilities for routing USB destined communication initiated at a host computer prior to standard host controller operations and sending them to a host controller device remote from host computer. The facilities include device driver level software configured to operate in one or more of Macintosh (, e.g. Mac OS X, etc.), IBM-PC (Windows based, e.g., 98/98SE, Win CE, Millenium, Win 2000, XP, etc.), Linux, UNIX and other host computers.

The present invention includes a standalone host controller, comprising, a network interface, a bus and at least one external port coupled to the bus, and a processor coupled to the bus and the network interface and configured to process communications passed between the network interface and the bus.

The present invention also includes a stand alone host controller, comprising, a network port, at least one USB port, and a transaction server, comprising, a login thread configured to receive login requests received over the network port from a plurality of individual host computers, wherein the login thread verifies a password, and upon verification of the password, sends a login response to the successfully logged in host computer that includes a list of all devices attached to the at least one USB port, and an operational thread configured to process messages between a successfully logged in host computer and one of the attached devices selected by the logged in host computer. The threads, are, for example software and/or firmware and/or other electronics programmed for the steps discussed herein.

In one embodiment, the present invention includes a method of operating a host computer, comprising the steps of, identifying placement of a host controller on a network, registering the host controller with the host computer, and registering the host computer with the host controller. In another embodiment, the present invention comprises a method of operating a remote host controller, comprising the steps of, detecting connection of a network to the remote host controller, and broadcasting a message on the network identifying presence of the remote host controller including an identification of the remote host controller. The remote host controller is, for example, a network attached device configurable to administer communications between host computers coupled to the remote host controller via a network and USB peripheral devices directly attached to the remote host controller.

The present invention also includes a method of setting up the stand alone host controller via a host connected to a network shared with the stand alone host controller. The set-up includes, for example, loading appropriate drivers into the host controller device, identifying specific hosts (by IP address) that are allowed to connect to the host controller device, identifying specific USB Devices which are available only to certain hosts or which require a password.

The present invention also includes a mechanism for handling USB hubs attached to the stand alone host controller. In one embodiment, an attached USB hub is handled as an extension of a root hub of the stand alone host controller, and are not visible to host computers as hubs.

The present invention includes a method for implementing a contention lock-out that prevents other host computer devices from using a USB peripheral attached to a network via the stand alone host controller when another host is using the USB peripheral. In effect, the contention lockout allows a single host computer to monopolize the network coupled USB device until the single host's use of the USB device is completed.

The present invention is a new way of managing USB (or other) devices over a network through a remote host controller. The invention includes facilities for sharing one or more USB devices with multiple host computers, messages configured for carrying information between a host computer and a remote host controller, and drivers for implementing portions of that management including packaging of messages sent between application(s) of a host computer and one or more USB devices attached to a remote host controller. Portions of both the present invention whether embodied in a device, method, or process may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a conventional USB implementation on a desk-top or portable host computer;

FIG. 2 is a block diagram and layout of an NHCI host controller and a host device configured according to an embodiment of the present invention;

FIG. 3 is a functional component diagram of an NHCI stand alone host controller and multiple hosts according to an embodiment of the present invention;

FIG. 4 is a layered drawing of a USB protocol stack incorporating an NHCI driver according to an embodiment of the present invention;

FIG. 5 is a diagram illustrating components of a NHCI host controller according to an embodiment of the present invention;

FIG. 6 is a flow chart illustrating an installation process of an NHCI device on a network and corresponding software modules on a host device according to an embodiment of the present invention;

FIG. 7 is a flow chart illustrating installation of a USB device attached to an NHCI port according to an embodiment of the present invention;

FIG. 8 is a flow chart that illustrates a process for routing USB intended communications from an application according to an embodiment of the present invention;

FIG. 9 is a flow chart illustrating an example data request from a Host and a data transfer from an NHCI device to the requesting host;

FIG. 10 is a flow chart illustrating an example sharing processes for when more than one remote host attempts communications with a single attached device in a same time frame according to an embodiment of the present invention;

FIG. 11 is a block diagram of an example implementation of an embodiment of the present invention;

FIG. 12A is a block diagram and data flow of an embodiment of the present invention;

FIG. 12B is a message structure diagram according to an embodiment of the present invention; and

FIG. 13 illustrates a set of NHCI devices installed on a network node according to an embodiment of the present invention.

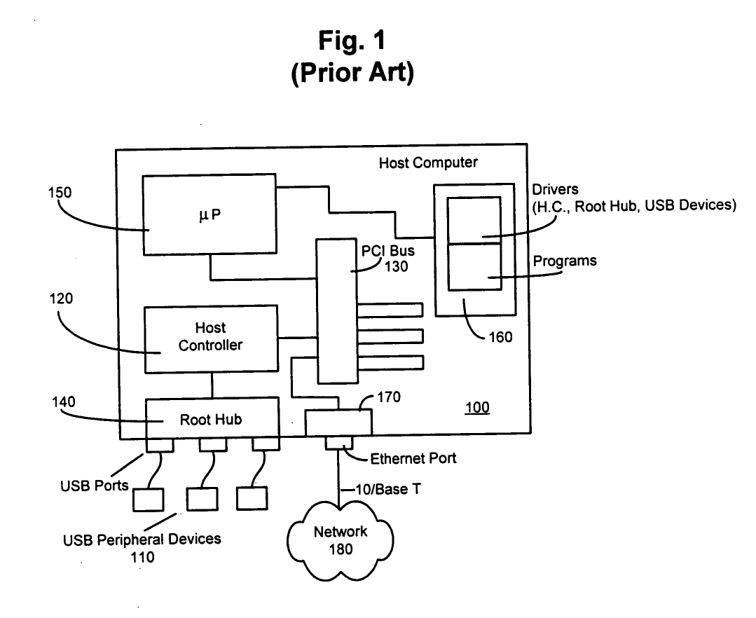

### DESCRIPTION OF THE PREFERRED EMBODIMENTS

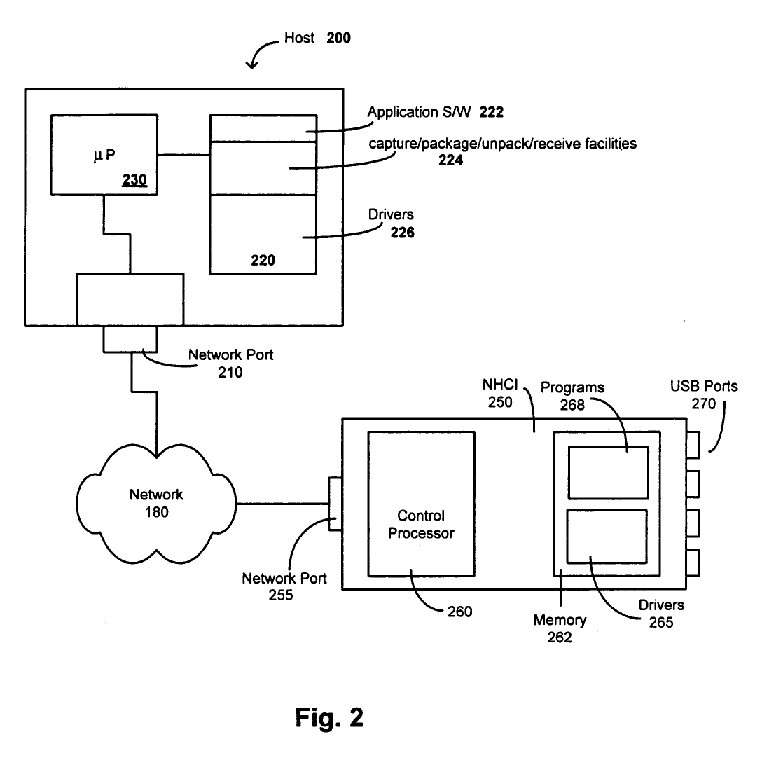

Referring again to the drawings, wherein like reference numerals designate identical or corresponding parts, and more particularly to FIG. 2 thereof, there is illustrated a block diagram and layout of an NHCI host controller 250 and a host device configured according to an embodiment of the present invention. Host computer 200 is coupled to a network 180 via an Ethernet port 210. The Ethernet port 210 is supported by commercial off the shelf hardware attached to the host computer.

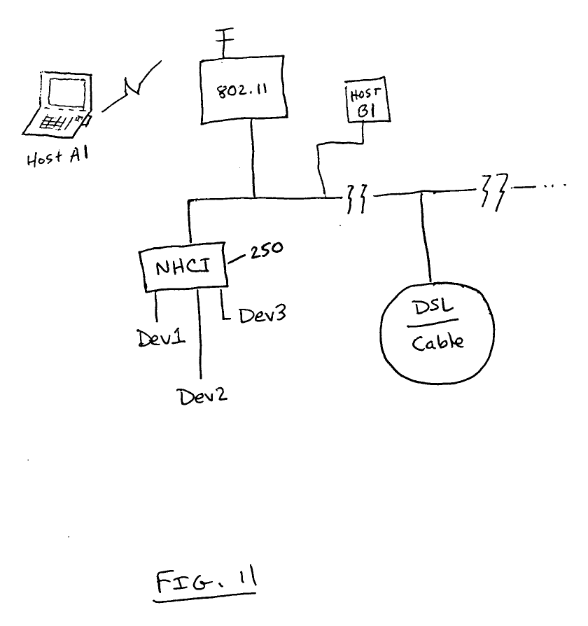

The NHCI host controller 250 is constructed according to one or more embodiments of the present invention and includes a network port 255 connected to the network 180. In one embodiment, the network port is a standard physical interface such as an Ethernet port having 10/Base T (10/100) type wired connections (e.g., RF45 connector), but could also be other types of connections including, for example, optical and/or wireless devices providing network access to the host computer and/or NHCI host controller. The network port may also be configured as a Wi-Fi (e.g., 802.11) or other wireless connection, LAN connection, or an internal interface to another system that provides network connection services. FIG. 11 is a block diagram of an example implementation of an embodiment of the present invention. As shown in FIG. 11, a Wi-Fi enabled laptop computer communicates with a network via an 802.11 connection. The network includes an NHCI device with three attached USB devices (Dev1, Dev2, and Dev3). The network is shown as including either a DSL or Cable connection for high speed Internet Access. Although illustrated as only having wireless connection or coupling for the Laptop-network connection, any of the illustrated network-attached devices may be attached via wireless connections of any type. Connections discussed with reference to the present invention include “connections” across a network that do not necessarily represent a direct physical connection.

The NHCI host controller 250 includes one or more USB ports 270. The NHCI host controller 250 operates to accept network messages from a host computer (e.g., host 200) intended for a USB device attached to one of the USB ports 270, unpackage the message and perform appropriate USB driver level operations on the data and/or command contained in the captured message, and forward that command and/or data to the appropriate USB port that is coupled to the USB device. The NHCI host controller 250 also performs a reverse functionality wherein queries, commands, or other data from an attached USB device is packaged into a “return” message and passed to a corresponding host computer on the network 180. The return message may be, for example, data returned from an attached scanner or digital camera, or the return message may be an initial message broadcast by the NHCI to one or more host computers on the network identifying that a USB device has been attached to one of the USB ports 270.

The NHCI host controller 250 includes a control processing device 260 for implementing NHCI host controller 250 processes embodied in programs 268, including, for example, network functions such as an IP stack, and processes for formatting data/commands into appropriate USB messages. A memory 262 maintains drivers 265 loaded onto the NHCI host controller 250 during installation (or pre-installed, as appropriate) of USB devices attached to the USB ports 270. The memory 265 may also be used to maintain programs 268 and data needed for operations of the NHCI 250 (e.g., network communications, etc.).

The invention includes various supporting software programs and processes performed on the host computer to route messages that would otherwise be intended for USB level communications at the host computer and package them into appropriate network messages directed to the NHCI host controller 250. The software and processes of the present invention at the host computer also include the necessary functionality to receive messages from the NHCI host controller 250 and to utilize any data contained therein in corresponding operations on the host computer.

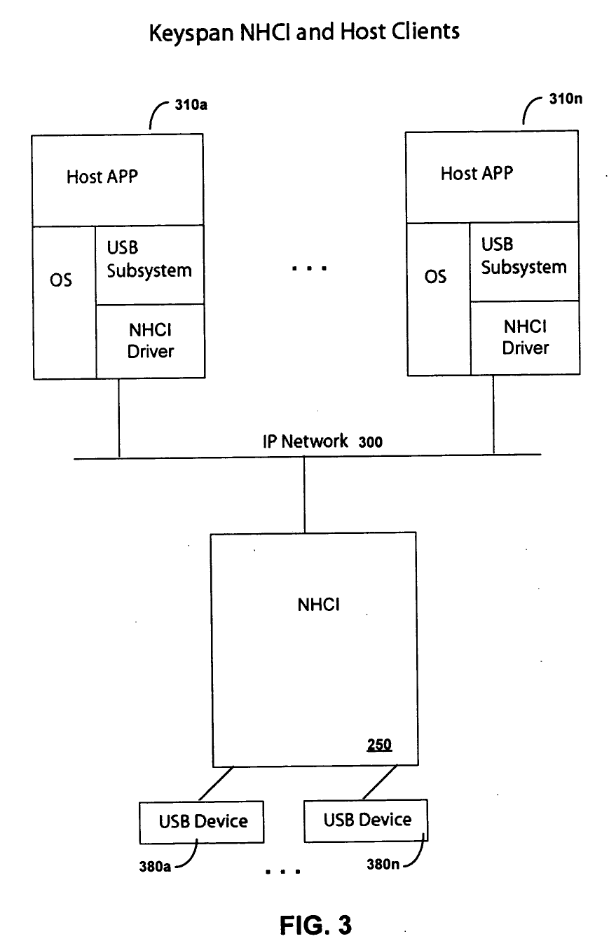

FIG. 3 is a functional component diagram of an NHCI stand alone host controller 250 connected via an IP network 300 to multiple hosts (e.g., hosts 310a . . . 310n) according to an embodiment of the present invention. Any number of hosts may be configured to have access to the NHCI 250.

Each of the illustrated hosts show a hierarchy of systems used to communicate commands and data to and from the host from/to the NHCI 250. A host application (host APP) is an application including appropriate user interfaces that requests access to a USB device to perform a function (e.g., a photo scan from a USB scanning device). The host applications communicate with an operating system (OS) of the host device and the operating system communicates with installed software (e.g., drivers) configured to package host APP requests and/or data and perform all the functions needed to transfer those commands and/or data to/from the NHCI 250. Compared to standard USB operations in which an example data request coming from a host APP is passed by the operating system to an OHCI driver and then on to a USB device via a PCI Bus in the Host computer, in the illustrated architecture, the host applications request/data is forwarded by the operating system to the NHCI driver for packaging and network communication to the NHCI 250. From the host application standpoint, the same communications between the host APP and the OS are performed whether using the present invention or standard USB communications. However, using the present invention, communications from the operating system are routed from the USB stack to an NHCI driver which is resident at the same level in the entire protocol as the OHCI driver. The NHCI driver forwards the communication to a network stack (e.g., IP stack) that prepares the communication to be placed onto a network and transmitted to the NHCI 250. The communication is then unpacked and placed on a USB Bus of the remotely located NHCI 250 where it is ultimately destined for a USB device attached to the NHCI. Each host represented in FIG. 3 is a view on the processes performed to allow communication between the Host computer and the NHCI 250.

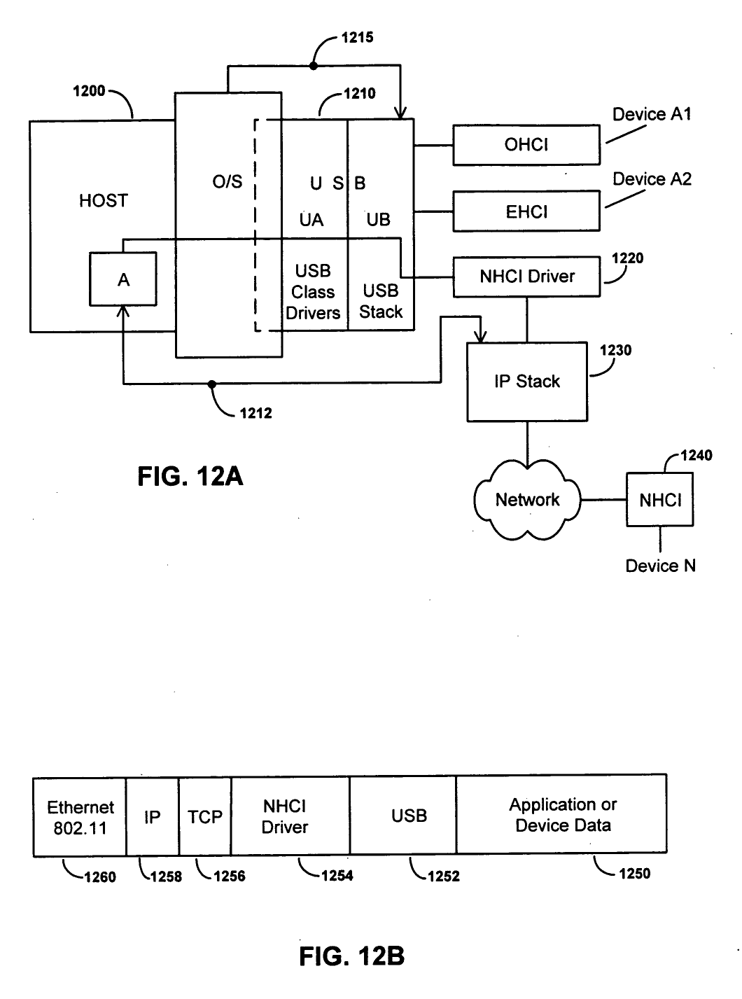

FIG. 12A is a block diagram illustrating a high level view of data flows and the various protocol levels and drivers interacting with a host 1200 having an application A in communication with a device N attached to an NHCI stand alone remote host 1240. Application data 1250 (or request/command) to a device N that has been “installed” on host 1200 is passed from the Application A to the USB subsystem (USB class drivers and USB stack) where the USB header information 1252 is appended. Based on the “installed” device's identifiers, the USB packaged data is forwarded to the NHCI driver 1220 where NHCI header data 1254 is appended, including routing information for the registered NHCI remote host controller to which device N is attached. The NHCI driver packaged data is then forwarded to an IP stack 1230 (appends IP/TCP info 1256/1258) and eventually placed on the network via, for example, an Ethernet card (appending Ethernet info 1260). Picked up at the NHCI 1240, the Ethernet and TCP/IP header data is stripped off, as is the NHCI driver data and USB header info which is also used to identify the ultimate recipient device, and the Application data 1250 is forwarded to the device N via the USB of the NHCI. Data from device N responding to an Application request is similarly packaged and sent back over the network to the Host following a reverse path.

FIG. 12B is a message structure diagram according to an embodiment of the present invention. The illustrated message structure includes Application Data 1250 from an Application (e.g., Application A of Host 1200). The Application Data 1250 is shown as encapsulated (having prepended header data) from the various protocol levels discussed above (USB Header data 1252, NHCI Driver Header Data 1254, TCP/IP 1256/1258, and Ethernet/802.11 header data 1260. The Ethernet/802.11 header data 1260 representing the protocol of the network on which the entire message is being delivered from a network port (Ethernet/802.11) on the host to a network port (Ethernet/802.11) port on the NHCI stand alone host controller (e.g., NHCI 1240).

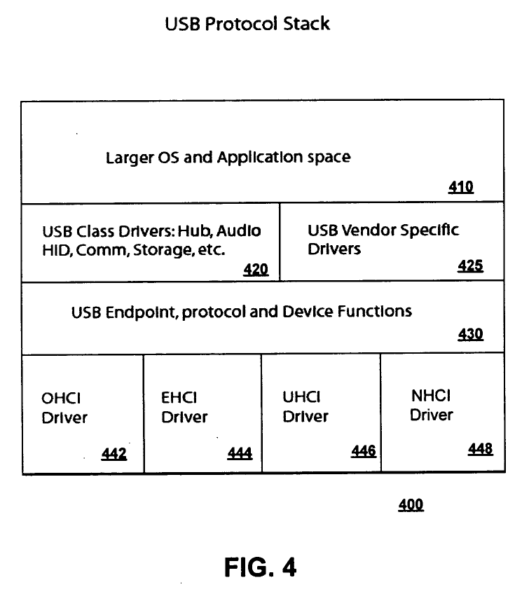

FIG. 4 is a layered drawing of a USB stack 400 incorporating an NHCI driver. The role of the USB stack is to manage the changing device membership of the USB device tree (USB devices attached to NHCI 250 and elsewhere) including communicating with connected devices, detaching from unplugged devices, and setting up the USB configuration for newly attached devices. The USB stack itself consists of two parts. The first part is the software required for participating in the USB protocol and the plug and play aspects of attaching/detaching or hot swapping of USB devices. The second part is the application specific code required to transfer data/command transactions from the host computer to a specified attached USB device. As noted in FIG. 12A, the USB 1210 includes class drivers (part A), and a USB stack (part B). Some operating systems (e.g., Mac OS X) have facilities that allow some operations using the USB stack to circumvent the USB class drivers. It should be noted that this does not affect operation of the NHCI processes discussed herein because the NHCI related messages/commands are indistinguishable from other USB related communications throughout the O/S, USB class drivers, and USB stack, and are only routed to the processes of the present invention only upon entering the NHCI driver 1220. Thus following a Mac OS X like communications path 1215 which utilizes that type of facility, a message destined for an NHCI attached USB device will still be routed to the NHCI driver 1220 upon exiting the USB stack.

The USB Stack 400 (FIG. 4) is another view on the processes performed to allow communication between the Host computer and the NHCI 250. At the top levels of the USB stack, applications and the host operating system interact. Communications from the Host application pass through the operating system (410) to any of the USB class drivers 420, USB Vendor specific Drivers 425, and USB endpoint, protocol and/or device functions 430 prior to the NHCI Driver 448. The NHCI driver 448 prepares the communications as needed for the standalone host controller NHCI 250.

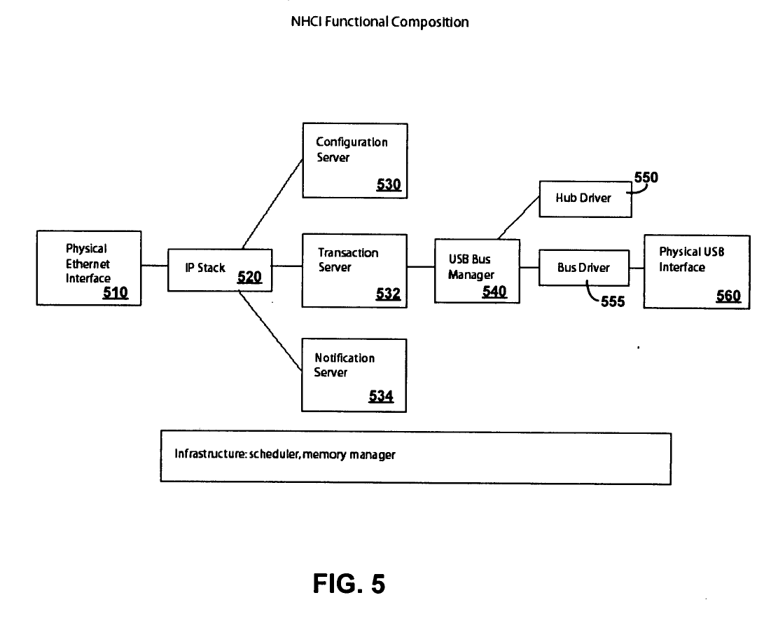

FIG. 5 is a diagram illustrating components of a stand alone NHCI host controller 500 according to an embodiment of the present invention. A Physical Network Interface (e.g., Ethernet) is provided for connection to a network (e.g., network cable). A protocol stack (e.g., IP stack) implements a communications protocol between the physical network connection and further processing/routing of messages directed to or from the stand alone NHCI host controller 500. In one embodiment, the protocol stack is an Internet Protocol (IP) stack that includes a network media interface driver, low level network protocols (e.g., ICMP, ARP, DHCP, ZeroConfig); an IP protocol layer, a TCP protocol handler, and a UDP protocol handler.

A configuration Server 530 interfaces with the IP stack. In one embodiment, the configuration server is realized in a separate software thread within firmware of the NHCI device. The configuration server performs functions related to the end-user configuration of the NHCI device (e.g., selection and setting of configuration data). Preferably, the configuration data set in this process is saved in the device in non-volatile memory (e.g., flash memory).

The primary mechanism for the end-user to access the Configuration Server is via a TCP port number and a dedicated configuration application running on the client host. The TCP Port number is provided in the UDP broadcast message from the NHCI. Several alternate mechanisms are also defined and implemented with additional software in the Configuration Server, for example, including:

An HTTP via a web browser;

Telnet over IP; and

Terminal access via a physical serial port, if one is available.

The configuration data includes, for example:

An IP Address type: static, DHCP or Zeroconfig;

An IP Address if static: IP Address (n.n.n.n), IP Mask, IP Gateway Address (m.m.m.m);

An optional DHCP ID, if DHCP;

A TCP Port for configuration Server, if different from factory default;

A UDP Port for notification broadcast data;

A TCP Port for Transaction Server, if different from factory default;

A configuration password (none by default);

A periodic Notification timeout;

A UDP broadcast on/off;

A list of specific client IP addresses, which get UDP messages and which are authorized clients (optional);

A list of wildcard client IP addresses which are authorized as clients; and

A list of specific USB devices (vendor ID, product ID and location ID/Serial#) with optional passwords or other validation data.

In one embodiment, processing logic of the configuration server comprises one or more of the segments of the following programming steps:

Wait for a TCP/IP connection on TCP Config Server Port (always the factory default the first time);

Accept messages in the form (2 byte length in network byte order, followed by payload; see also NHCI Network Message Specification);

If configured, require a ‘login’ message containing the correct password. If not provided by the configuration client, disconnect the TCP session;

Otherwise, respond to query/command messages from the client;

Login;

Logout;

Get Current Settings—send response with current values of above configuration parameters;

Set Value—for a provided parameter name, replace the saved value with the given value;

Reset Factory Defaults—a copy of the original factory configuration is saved in Flash memory, not subject to change. Replace any configured settings with the factory defaults; and

Reset Device—causes a disconnect and reboot.

A Transaction server 532 is coupled to the IP stack. The transaction server is configured to process messages passed to/from the IP stack and from/to the bus, including processing required to add and/or interpret headers, build messages, and package/unpackage data within the messages. The messages passed between the IP stack and bus include, for example:

Reset Endpoint messages which initiate a USB control transaction to reset a particular USB endpoint for a given USB device; and

Data Transaction messages which initiate a particular USB transaction for a particular USB endpoint for a given USB device (For example, transaction will continue until completed, the endpoint is reset, or some error or other terminating condition).

Also, messages sent to the transaction server, or NHCI device as a whole, comprise:

Logon/Logoff messages used to register a host with the NHCI; and

Attach/Detach messages which register a host with a specific device on the NHCI. The attach message indicates a client's interest to “install” a particular device. The detach message is sent to indicate that a host is no longer interested in a particular USB device.

In one embodiment, the Transaction Server is a software thread within firmware of the NHCI. The transaction server comprises the main processing functionality of the device which is based on a set of query/command messages from the client and their associated responses. The messages follow a general format of two byte message length, followed by payload which comprises the general command header and followed by any data associated with that command or response.

In more detail, the command/queries are:

Login—to establish a session with a server (e.g., transaction server) on an NHCI device. If the server requires a password, the client (or host) system provides it, for example, in the Login message. The LoginRsp (response) that is returned to the prospective client will include an indicator of either a successful connection or an error. The error may mean that the password is invalid or that the server has reached its limit of client connections. If a password is bad, disconnect the TCP session immediately for enhanced security.

If a good login is indicated, the LoginRsp message also includes a complete list of all attached devices that are either 1) under the default sharing model or 2) configured to specific assignment to the IP address of the given client. This device list also includes the USB Descriptor cache.

Attach—client asking for access to a particular device defined by vendor and product ID and locationID/serial number. The AttachRsp indicates either a successful or unsuccessful attach. If successful, the client may initiate communications. The successful attach does NOT mean that exclusive access has been granted. That begins with the first message sent from the Host Client to the NHCI server which requires physical interaction with the device. If the server can grant exclusive access at this point to the given client, it does and locks out any other potential client, attached or not. If the Server cannot grant exclusive access it returns an error to the client. The client indicates a local “USB Device Removed” event as a result. Optionally, the client puts up an Alert message to inform the end user of what has happened. The Server maintains an activity timer on all exclusively assigned devices and after all transactions have been completed and if no new ones are presented for 3 seconds (or other configured time out period), the exclusive access is released. Upon this change, the Notification Server is called to re-send information that the device is available (e.g., a server broadcast UDP message, which by default maintains the locality of the NHCI because UDP broadcasts do not go past routers, or, in reserved or subscription cases, a narrow cast to a specific list of addresses).

The present invention includes several models for making an NHCI available for use by host systems. Each of these models include a registration procedure for the model, including:

Sharing registration—A registration procedure where the NHCI device and it's attached USB devices are available for sharing amongst all host devices on a same network segment (extent of UDP broadcast message traffic). Hosts receive a broadcast message indicating presence of the NHCI device and are then free to browse the available devices, “install” them on the host, and are then subject to an arbitration mechanism so that the hosts do not communicate with any one of the USB devices at the same time. In one embodiment, the UDP broadcast messaging protocol is utilized for location and device availability messages within the Sharing model because, by design of the UDP broadcast messaging system, these messages stay on the same segment (e.g., most routers do not pass UDP communications to other segments ), thus making the NHCI device available only to local hosts. Preferably, the sharing registration model is the default upon installation of the NHCI device on a network and the NHCI driver and related software on the host In this Sharing Model, the Host Client Login is restricted to IP addresses on the same segment.

Reserved Registration—A registration procedure where specific IP addresses maintained in a list are notified of the presence of an NHCI device and are also allowed to register with it. The list is, for example, a list of IP addresses, and hence may include non-local registrants, transcending network segment boundaries. The list is used to narrowcast messages identifying presence of the NHCI device on the network. The list is used to verify eligibility of a host attempting to register or register with the NHCI device. In one embodiment, a reserved registration technique utilizes an arrangement where a single USB port on an NHCI device is reserved for a specific one or set of Host systems. In another embodiment, an NHCI device is configured so that specific USB devices are reserved for one or a limited set of Host devices. The specific USB devices are identified, for example, by one or more of vendor id, product id or locationID/serial number. Once configured, the NHCI sends notifications, upon attachment of one of the specific devices, only to the limited set of hosts; and

Subscription based registration—A registration process where an application on a Host system sends a request to an NHCI device for a subscription request. The location of the NHCI device may be determined, for example, via a well-known port, an address, DNS, or URL provided with a driver or other installation software, or a broadcast message. A login/password or other verification mechanism (e.g., sent with the subscription request) may be used to verify eligibility of the requesting host (e.g., communicated directly to the NHCI via normal network communications—see comm 1212, FIG. 12A, for example). With a valid logon/verification, the NHCI sends a list of devices available for that subscriber (e.g., comm 1212). The devices on the return list are available to be “installed” on the subscribing Host device. Note that this communication path, while it still uses TCP/IP, is completely independent of USB until the point where a successful device selection has been made. At that point, the NHCI will send (not broadcast) the same or similar UDP message as used in the default sharing model to the given host to start the USB device connection process.

The registration or sharing processes are preferably configured in the beginning of the installation process, and during installation of the NHCI driver at the host computer. Subsequent host installations then generally follow the same sharing model as other hosts using the same NHCI device. Of course, further installation options allow other sharing models, and/or use of sharing models other than those already installed on a specific NHCI device, but would only normally be performed by advanced users. For ease of installation (Quick start, etc.), preferably, the user selects the default sharing model, or the default sharing model is automatically installed and changes or different sharing models are installed upon use of an advanced or other options menu at a later time. The main idea being to get users up and running with the easiest installation and then let the user fine tune the installation based on the user's needs and technical savvy.

Once a client is attached, the following Transactions (e.g., received from the attached clients) are valid and processed by the transaction server

Control

Bulk-In

Bulk-Out

Interrupt-In

Isochronous-In

Isochronous-Out

Reset

An example set of processing logic follows:

A. Wait for TCP/IP client connections.

B. By default, only accept client connections from addresses local to the network segment of the NHCI device. However, if configured, test the prospective client IP address against the list of either 1) wildcard IP addresses or 2) the discrete list of IP addresses; in order to decide whether or not to accept the connect.

C. If accepted, start a new thread which reads TCP messages from the new client. See the NHCI Network Protocol Specification for message format details.

D. Initially, only accept the ‘login’ message

E. If a ‘login’ message is received, check to see if this device requires a password and if so, make sure the login message contains it (the process uses, for example, an encoding scheme to protect against snooping).

F. If the login is invalid, send back a loginRsp with a fail return code and disconnect the TCP session.

G. Otherwise, send back a loginRsp with a positive result code and a list of all attached USB devices not marked for ‘Subscription sharing’: vendorID, productID, locationID, device password required indicator and USB Descriptor cache.

H. If an ‘attach’ command is received, check that the associated device is valid. If ok, send back a positive response along with a Server Reference ID. If not, send back NULL. The Server Reference ID is used by the client on any subsequent detach or transaction message. Each TCP client/server session will support multiple individual device ‘sub sessions’. Note that the client access to the given device is not exclusive until the first active device transaction is received.

I. If a ‘detach’ command is received or ‘logout’ command received while a device is attached, the device is disassociated from the given client and the server cancels any pending transactions.

J. If any of the active transaction messages is received, check that the device is assigned for exclusive access for the given client. If not, and the device is not already assigned, assign it and start the transaction activity timer which will expire 3 seconds after the last transaction completes. If the device is assigned to another client, return a “device not available” error code. The client is expected to treat this like a detach and indicate a local “USB Device Remove” event.

K. If a ‘Query Subscription’ message is received, first check that any required NHCI Password is provided and correct. If the password is bad, return an error and disconnect the TCP session. Otherwise, return a ‘Subscription Response List’ message which includes a list of all local USB devices available under subscription request. This data includes all of the usual USB Device identifiers, all of the USB Descriptor cache and an indicator of password required. If this exchange is successful, a special session is established upon which ‘subscription requests’ are accepted.

L. If a ‘Subscription Request’ is received on a special ‘subscription’ session, first check that any required password is provided and correct and that the indicated device is available. If it is, call the notification manager to narrowcast a device available message to the subscription client. This device is subsequently handled in the same manner as default-shared devices.

A Notification server 534 is also coupled to the IP stack.

In one embodiment, the Notification Server is a separate software thread within the NHCI firmware. It sleeps until either expiration of a timer or an event is received. These events include: Add USB Device, Remove USB Device, USB Port Over-current.

The various notification messages described below (and whose detailed format is documented in the NHCI Network Protocol Specification) are sent via UDP/IP on the default or re-configured UDP Port. If UDP broadcast is not disabled, these messages are broadcast on the particular UDP port. In addition, if the configuration data includes a list of discrete authorized IP clients, these messages are also sent individually to each of those clients.

An example set of Processing Logic for the notification server comprises:

If the Notification Server timer expires, send the nbsInitial message with Transaction Server's TCP Port number;

If an Add Event is detected or if a device has gone from exclusive to non-exclusive availability, send the nbsAddDevice message, with the device's USB Vendor ID, USB Product ID and location ID (an opaque 32 bit value which defines where the device is plugged in) or USB Serial#;

If a Remove Event is detected, send the nbsRemoveDevice message with VendorID, ProductID and locationID as above;

If a port Over-current condition is detected, send Device Error msg; and

If a port over-current condition has been cleared, send Device available msg.

The USB Bus manager 540 is coupled to the Transaction server 532 and uses Bus driver 555. It is the function of the USB Bus Manager to maintain and process a queue of all pending USB transactions on all of the USB devices connected to the NHCI device. This includes HUBs and other devices for which local device drivers provide entirely local management.

In general the NHCI device comprises one or more separate physical USB busses. Each is managed separately.

USB is time sequenced with the significant unit of time being the frame. The “Start of Frame” (“SOF”) occurs once per millisecond. Generally a hardware clock is responsible for both the bit clock and the SOF clock. The “Frame Number” is the ordinal number of frames that have passed since the last Bus Reset.

All of the queued transactions are provided for connected USB devices from either a host client via the Transaction Server or a local (e.g. Hub) driver. The Transaction Server and Bus Manager manage USB bandwidth and ensure that transactions provided to the USB Bus Manager do not exceed the available bandwidth.

Preferably, transactions in the transaction queue are maintained in first in first out order. All transactions include bus number, function (Device) address, endpoint number and direction. In addition, Input Interrupt transactions include an endpoint polling rate (provided in the endpoint descriptor). Isochronous transactions are generally scheduled for some specific future frame number.

Just before the beginning of every frame, the USB Bus Manager determines which transactions are required for the upcoming frame and creates a “Transaction List” which includes the transaction descriptors and any associated data. The Transaction List is then loaded into the USB Bus Driver. At the end of the frame the Transaction List is retrieved from the USB Bus Driver. Completed transactions are then removed from the queue and dispatched back to their source.

The USB Bus Manager manages USB Transactions for particular USB Devices on behalf of one of several different clients. Devices that are “owned” by some external Host Client of the NHCI send and receive their data via the Transaction Server. For these devices, the Transaction Server is the USB Bus Manager's client. Other devices may have a local driver (e.g. HUBs) and in this case the local client of the USB Bus Manager is the device's local driver. If the device doesn't have a local driver and is still not owned by an external client, the local client is a set of USB Device Manager programming that is preferably maintained in the USB Bus Manager (in this embodiment, the USB Bus Manager 540 includes USB Device Manager programming). Alternatively, functionality of the USB Device manager programming may be maintained in a separate unit apart from the USB Bus Manager 540.

The USB Device Manager is responsible for the low level detection of Device Add and Device Remove events. When the USB Bus Manager determines that a new USB Device has been plugged into one of the root HUB ports, or when the HUB driver has received a message from an actual USB HUB downstream from one of the root hubs, control is passed to the USB Device Manager. The USB Device Manager then performs the following steps to make the device ready to be shared and used:

A physical USB device address is assigned to the device;

The USB Device Descriptor is read to determine the type of device; and

For each of the different USB Device Configurations, as defined in the Device Descriptor, the USB Configuration Descriptor (which under the USB Specification includes all of the associated Interface and Endpoint Descriptors) is read.

Once these descriptors have been read, and assuming that no error has been detected, the local preset device definition tables are consulted for one of the following:

If there is an actual USB Device Driver for the device local to the NHCI, HUB for example, that driver is called and given control of the device;

If the device is found in the USB Device Configuration entry table, the configuration setting is consulted for which sharing model to apply to the device. If it is the “default” sharing model, or if the device is not found in the table at all, the Notification Server is called to broadcast and/or narrowcast the existence of the device as appropriate; and

If the device is found to be configured with the “subscription” sharing model, it is added to a table of potentially available devices, but its existence is not broadcast.

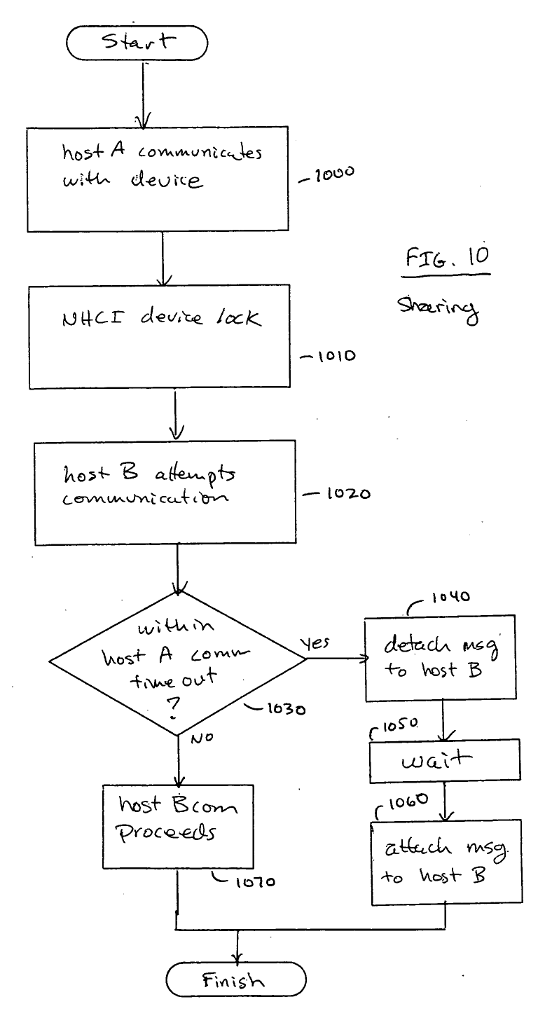

FIG. 10 is a flow chart illustrating an example sharing processes for when more than one remote host attempts communications with a single attached device in a same time frame according to an embodiment of the present invention. As shown in FIG. 10, at step 1000, a first Host, Host A begins communicating with an attached device. The attached device is then locked such that only communications to/from Host A are allowed with the device. When a second host attempts communication while the device is locked to Host A (step 1030), an error message is sent to Host B (step 1040). After a wait period (step 1050), the attached device is provided the opportunity to reattach (via an attach message, step 1060). If Host B's communication is not at the same time as Host A's communication nor within the prescribed time out (step 1030), the Host B communication proceeds (step 1070).

The Hub Driver manages operations of the hub supporting multiple USB interfaces 560. A HUB is a special-case USB device with the NHCI. Because of the various USB Device sharing models and due to the fact that USB HUBs are themselves USB Devices like any other, HUBs are not shared like other devices.

Preferably, a USB Hub plugged into the NHCI device is not available to be owned nor is it visible beyond the NHCI device itself. In one embodiment, the NHCI includes a complete USB HUB Device which runs locally and which entirely owns any HUB plugged into the NHCI.

In another embodiment, given the appropriate configuration data, the HUBs that are part of USB Compound Devices may be exposed and shared externally in such a way that one Host Client will always own the Hub and all of the devices connected to it within the Compound Device. In this case, the Compound Device and attached USB devices (if any) are assigned or unassigned as being available as a group for registration to one or more particular hosts. Each host assigned to the compound device then is granted the ability to register the compound device and any of the USB devices attached to the Compound device in a manner similar to that discussed herein for individual USB devices attached to the NHCI.

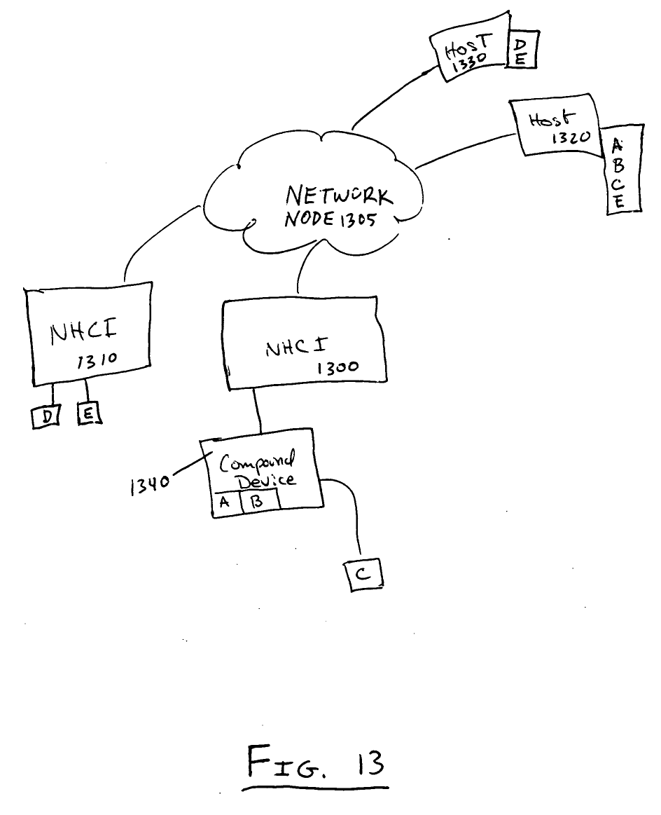

FIG. 13 illustrates a set of NHCI devices 1300, 1310 installed on a network node 1305 according to an embodiment of the present invention. Two Host computers 1330 and 1320 are located on the same network node 1305. NHCI 1310, is for example, setup as a sharing NHCI and each of Host 1330 and Host 1320 are illustrated as having registered NHCI 1310 and as having access, according to the processes of the present invention, to at least one of the attached USB devices D and E. NHCI 1300 is a subscription or reservation based NHCI device. Host 1330 is not granted access by subscription nor is it on a reservation list of NHCI 1300. Host 1320 is illustrated as having either been accepted on a subscription, or, being on the reserved list of NHCI 1300. Host 1320 is also illustrated as having created a connection (access) to the compound device 1340 (e.g., Host 1320 “installed” USB device A, an integral component of the compound device). Upon registration of the NHCI 1300 and establishment of the connection from Host 1320 to the compound device 1340, all additional devices attached to (e.g. USB device C) or associated with (e.g., devices A and B) the compound device are accessible to Host 1320. In fact, Host 1320 is illustrated as having installed devices A, B, and C.

When the NHCI internal HUB Driver detects a new USB device plugged into it (e.g., via status query transactions completed with data indicating an Add Device), information is passed to the USB Device Manager so that the new device can be identified and managed in the same manner as it would be if it were plugged into one of the NHCI Root ports.

The USB Bus driver performs the necessary package/formatting needed to place USB communications on the USB. The NHCI Bus Driver is responsible for performing individual USB message/control transactions on one or more physical USB busses. This includes performing all of the specific Host/Device message exchanges that are defined in the USB Specification for each transaction type. The unit of work for the Bus Driver is one USB Frame. The USB Bus Manager is responsible for scheduling all transactions for a given physical Frame and passing all of the required data for those particular transactions to the Bus Driver.

Preferably, the Bus Driver runs as many of the provided Transactions, starting at the beginning of the list, as possible within the 1 ms USB Frame. At the end of the Frame all of the results (completed, aborted or incomplete) are made available back to the USB Bus Manager.

The physical USB interface 565 receives the USB Transactions from the Bus Driver and provides completed USB Transactions from an attached USB device back to the Bus Driver. In one embodiment, The NHCI looks to any USB peripheral exactly like either an emulated Root hub within any Host Controller or a standalone self-powered Hub. It is, for example, populated with one or more USB “A” connectors across one or more physically separate USB busses. Preferably, these interfaces support USB 2.0 slow and full speed devices and, optionally, high-speed devices.

The present invention includes necessary facilities to install software components (processes, drivers, etc) in both one or more host computers and the stand alone NHCI host controller. Referring to FIG. 2, a memory 220 is illustrated having application software 222, NHCI related software 224, and drivers 226 loaded therein. The NHCI related software 224 includes software configured to receive commands, data requests, and other instructions from one or more applications that are intended for a NHCI connected USB device. The NHCI related software also contains facilities for packaging and sending the received commands, data requests, and other instructions over the network 180. In addition, the reverse operations are also supported, that is, the receipt of data, requests, and/or other instructions received from the network 180 and providing them to a corresponding application. The described processes and facilities are preferably written as software components (programs, drivers, etc.), but may also be fashioned from electronic components.

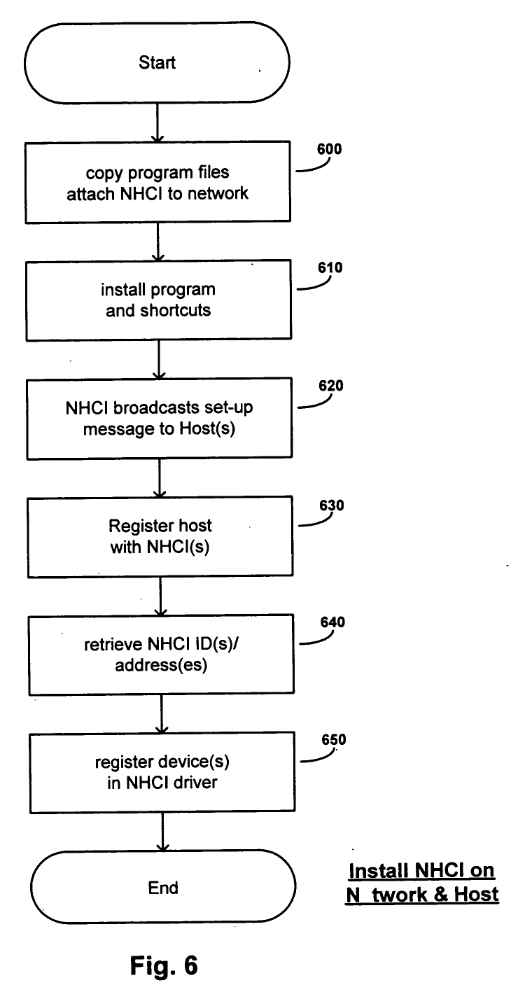

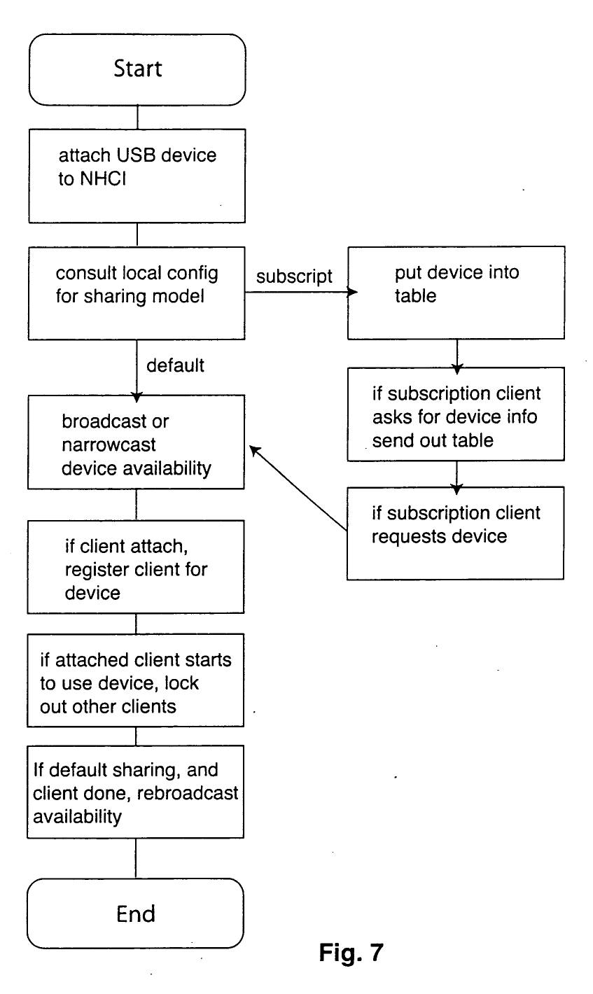

Installation of the described processes is now described with reference to FIGS. 6 and 7. FIG. 6 is a flow chart illustrating an example installation process of an NHCI device on a network and corresponding software modules on a host device according to an embodiment of the present invention. FIG. 7 is a flow chart illustrating an example installation of a USB device attached to an NHCI port according to an embodiment of the present invention.

Once devices are installed at the NHCI and appropriate software installed at one or more host computers, the host computers may register to use the devices (e.g., USB devices) In one embodiment, registration of a USB device to a host computer, via the NHCI, is done with a trusted registration. That is, security hurdles are met by the host device and/or NHCI prior to making the registration which allows the host computer to access the USB device or to communicate with the USB device. A trusted registration process may include, for example, receiving an encoded password from the host computer. Encoding may be performed via DES or other related encryption technologies shared between the host computer and NHCI. Decoded at the NHCI, the password is validated by, for example, comparing it to a list of valid passwords or against a test password generated at the NHCI. The host computer is then notified of success or failure in establishing the trusted connection based on the password validation.

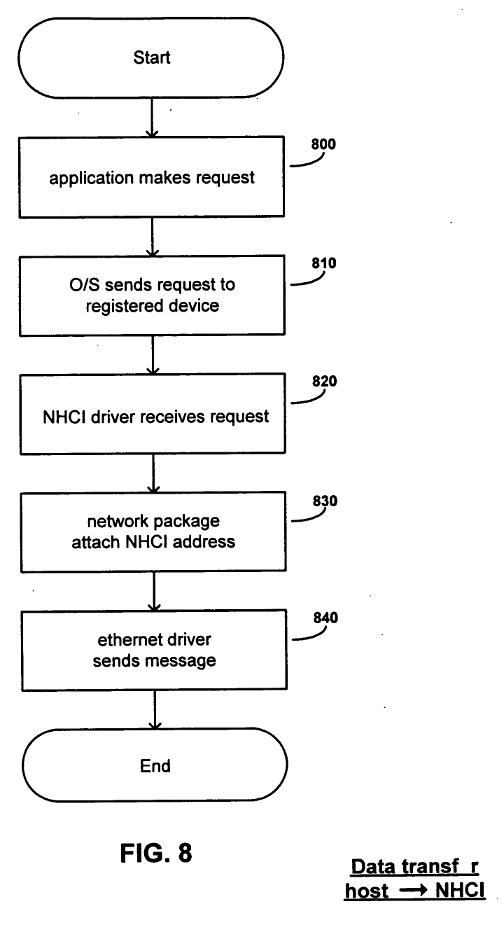

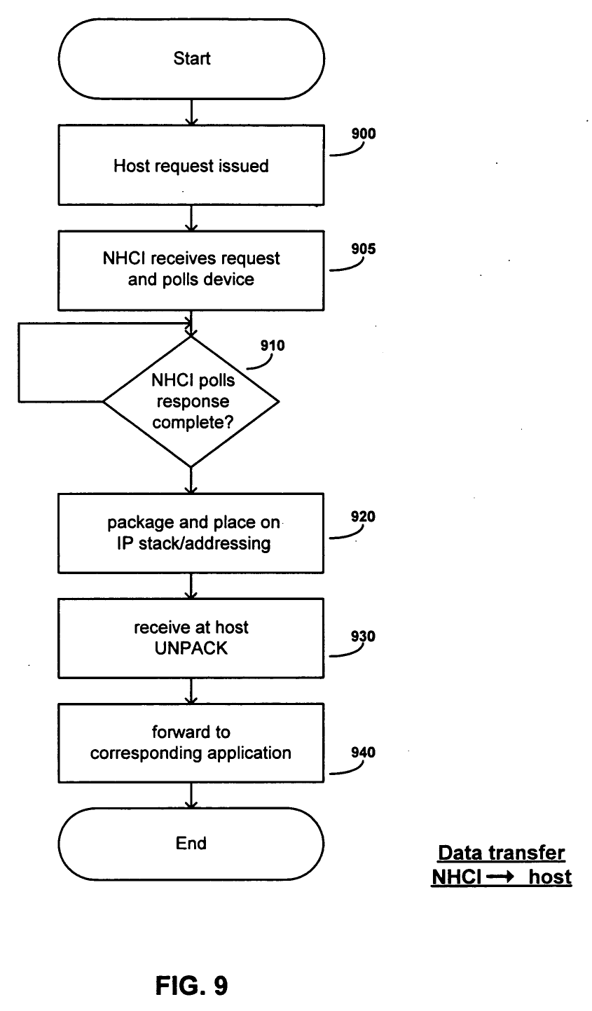

Data transfers between applications running on one or more host computers and USB devices attached to an NHCI are now described with reference to FIGS. 8 and 9. FIG. 8 is a flow chart that illustrates a process for receiving USB intended communications from an application according to an embodiment of the present invention. At step 800, an application on a host computer (e.g., host 1200) makes a request directed toward a USB device “installed” on the host computer, but physically attached to an NHCI device registered with the host. The operating system of the host forwards the request to the registered device noting appropriate identifiers to the request and forwarding it to the USB (step 810). The NHCI driver receives the request and routes it to a network stack (e.g., IP stack 1230) and prepares the request to be routed over the network (e.g., via an Ethernet card).

FIG. 9 is a flow chart illustrating an example data request from a Host and a data transfer from an NHCI device to the requesting host. At step 900 a host device makes a data request (e.g., a post read command specifying Bus, Device, and endpoint). The data request flows, for example from an application running on the host through the USB stack in accordance with normal USB communication scheme. The request is then picked up by the NHCI driver (e.g., driver 1220) and packaged for communications over a network to the NHCI. At step 905, the NHCI receives the request from the network. The NHCI reads the request and begins polling the USB device to which the request is ultimately directed. When the request is fulfilled (e.g., step 910, a single response or a series of segmented responses is received in response to the poll(s)), the NHCI takes the response and packages it for communication back over the network to the requesting host (step 920). The host then unpackages the response and forwards it to an application that originated the issuance of the host request.

The following 16 sections provide a discussion that describes various embodiments of device drivers that are utilized on the Host computers. The discussion is intended to be independent of any particular hardware implementation and is not intended to limit the invention in any way, and is provided as a guide as to how the drivers could be implemented. It will be apparent to the ordinarily skilled artisan, based upon a review of the present disclosure, that other techniques and processes may be utilized to effectively produce drivers able to operate consistent with the present invention as described herein.

1. Driver Overview

The NHCI is a network attached USB Host Controller. USB Devices are attached directly to the NHCI device and it provides USB bus services to various desktop and/or mobile computers connected via an IP network. This connection has a client/server nature where the NHCI Device is the Server and the variously connected hosts are clients. In this document the NHCI may be described as the “NHCI”, “NHCI Server” or just “Server”. The networked attached Host machines that use the services of the NHCI Server to connect USB devices are known as “Host Clients” or just “Clients”

The NHCI Host Client Device Driver is software that runs on the Host Client platform (e.g. a machine running Windows XP) and provides a connection between the NHCI Server and the Host Client's USB subsystem.

The NHCI Device Driver Specification includes the following:

Host Platform device driver context

Driver's relation to USB stack

NHCI Server discovery

NHCI Server connection

USB Device Discovery & Connection

Cached descriptors

USB Transactions

USB Endpoints and Bandwidth Allocation

USB Data Transactions

Control Transactions

Bulk Transactions

Interrupt Transactions

Isochronous Transactions

Implementation Notes for Windows 2000/XP

implementation Notes for Mac OS X

2. Host Platform Device Driver Context

The NHCI Device Driver (“Driver”) is the software interface between the NHCI device and the USB protocol stack of the Host. It uses mechanisms appropriate and specific to a particular host platform (e.g. Microsoft Windows XP).

The Driver uses the standard IP protocol stack on the particular host to communicate with the NHCI server.

3. Driver's Relation to USB Stack

The Driver forms a part of the existing USB protocol stack that roughly corresponds to that of the device driver for another type of USB Host Controller, the PCI-attached OHCI or EHCI chip that nearly every modern desktop or portable computer contains.

It is the function of the Driver to support all appropriate and necessary interfaces within the USB protocol stack such that USB devices plugged into remote NHCI servers appear to be locally connected USB devices to the USB protocol stack and all class and vendor specific drivers on that platform.

4. NHCI Server Discovery

The Driver sets up a thread or other appropriate software control structure to listen on the well-known UDP port on which the NHCI server broadcasts. These messages indicate the existence of the server and may also advertise that a new USB device has been connected.

5. NHCI Server Connection

When a new NHCI server is discovered, the Driver uses the TCP port number found in the UDP broadcast message to setup a TCP session with the server. If the server requires a password and the Host client has one, it is provided as part of the session logon message. If the login is successful, the Driver effects the appropriate USB-protocol-stack function to instantiate a new USB host controller with the indicated number of physical busses and USB ports.

Part of the function of any USB Host Controller driver is the management of the “USB Root Hub.” Because of the USB Device sharing model of the NHCI, real downstream USB Hubs connected to the NHCI are generally managed by the NHCI server itself and not seen by the Host Clients. Accordingly, the total number of downstream ports on the NHCI and all of its downstream Hubs are managed under the local “Root Hub” abstraction. Locally this is, for example, initialized to the maximum of 15 ports. One variation of this occurs with the logical hub that is contained within USB “compound” devices, as described elsewhere herein.

6. USB Device Discovery & Connection

Available devices on the NHCI are indicated to host computers in two ways. First, when initially plugged in a UDP message is broadcast by the NHCI with device information. Second, the NHCI response to a successful login contains information on all attached devices.

When a new USB device is discovered by the NHCI and made known to the Driver, the Driver in turn indicates a status change on one of its virtual root Hub “ports”. The root hub driver, or the NHCI Driver itself, as appropriate signals an “Add USB Device” event for the local host. This results in the beginning of a sequence of device discovery and configuration. The local stack will start by attempting to assign the “new” device a USB bus address. Since the NHCI will have already done that, the “Set Address” function is terminated locally and the address saved to provide a map between the local USB protocol stack and the device information exchanged with the NHCI server.

7. Cached Descriptors

The device discovery process starts with the reading of USB Device, Configuration and other USB descriptors. These requests are satisfied by the Driver, to the extent possible, from a cache provided by the NHCI server of all USB descriptors for the given device. In this way, multiple Host Clients can do this device discovery in parallel, each ‘thinking’ that it owns the device.

8. USB Transactions

The cached descriptors and other information provided by the NHCI server is enough for the host to match the USB device with a driver. Note that this matching process is exactly the same as that for USB devices plugged locally into the host system. If a suitable driver is found, it is loaded and started in the usual way. Once the driver starts actual communication with the device that goes beyond reading of the cached descriptors, an appropriate USB transaction message is sent to the NHCI server. When the server receives a message that requires exclusive access to the device, it attempts to arbitrate exclusive access for that client to that device. If it can create such an access, the given transaction is initiated by the server and a positive response is returned. If not, an error indicating “device not available” is returned to the client. If this happens, the client then signals “USB Device Removed” to the local USB stack. Optionally, an Alert may be displayed to inform the end user. This triggers the most appropriate end user experience. It also takes advantage of the dynamic “plug and play” character of USB device drivers.

Given this mechanism, clients can be in any one of three states with respect to a particular device:

those that have seen the device existence message from the server, but have not tried to use it;

those that have tried to use the device and have succeeded in obtaining exclusive access and;

those that have tried to obtain access and failed because someone in state #2 got there first.

Because clients in case #3 will have signaled “USB Device Removed” when they tried and were unable to get access to the device, the server broadcasts a new “Device Available” message whenever a given device's exclusive to one client expires.

The server maintains a three second inactivity timer such that if any client with exclusive access to a device has no transactions pending for 3 seconds, that device/client exclusive connection is terminated and the device once again made available for anyone.

9. USB Endpoints and Bandwidth Allocation

As USB devices are discovered on the NHCI and matched with drivers on the Host Client, those drivers will select and attempt to activate particular configurations. Those configurations have sets of endpoints. It is the responsibility of the NHCI Driver to make sure that the collective bandwidth of those endpoints does not exceed the available physical bandwidth on the connection between the physical device and the NHCI.

In addition, it is the responsibility of the NHCI Host driver to allocate and arbitrate USB bandwidth in the manner that is appropriate for the local USB stack. Depending on the particular implementation, the NHCI device may have one or more physical USB busses.

10. USB Data Transactions

The NHCI Driver sends USB Data Transactions to the NHCI over the TCP session that it maintains with the Transaction Server within the NHCI. See “NHCI Network Protocol.doc” and NHCImessage.h for more details. Each transaction comprises a message from the driver to the NHCI that begins with the netUsbTransHdr structure. This transaction is executed by the NHCI and a response sent back to the driver. There is generally a one to one relationship between transaction initiation message from the Driver and the corresponding response from the NHCI, where the exceptions include long data receive messages and certain errors.

For example, when the Host Client wants to read from a certain USB Endpoint on a particular USB Device, the NHCI driver sends an appropriate ‘Read’ transaction with a length. The NHCI will continuously read the appropriate endpoint until data is available, or an error occurs, and return the response transaction at that time.

11. Control Transactions

A control transaction consists of a “Setup” stage, an optional “data” stage and a “Status” stage. Generally the “Setup” stage is used to send a standard format 8 byte “Device Request” to the device. The kNtrControl message format is used to transport this to the NHCI, including any “Data” stage output data. The NHCI generates a kNtrControlRsp to return status and, if present, any “Status” stage data to the host. In each direction, the data is assumed to fit within one NHCI transaction data payload.

12. Bulk Transactions

Bulk Out Transactions are broken up into units of NHCI payload (ensuring a multiple of the particular endpoint's maximum packet size) and sent separately to the NHCI with a kNtrBulkOut header, each unit generating a kNtrBulkRsp. This sequence is managed so that the entire transaction is indicated as complete back to the USB stack when the response to the last message is received.

Bulk In Transactions are initiated to the NHCI, regardless of length, with a single kNtrBulkIn message. The NHCI then returns one kNtrBulkRsp message for every NHCI payload worth of data. Because USB allows such a transaction to terminate cleanly at any length up to the requested maximum, it is not possible to know how many kNtrBulkRsp messages will be returned. The final returned message will be marked with a “final” marker.

13. Interrupt Transactions

Interrupt Transactions are one direction only: Input from the USB device to the Host Client. They are handled exactly the same as Bulk In Transactions except that the NHCI manages the execution of queued transactions within a USB frame according to the USB protocol rules. Interrupt Transactions have a higher priority than Bulk and are “polled” at a rate (fastest is 1/frame, slowest is 1/32 frames) indicated by the associated Endpoint Descriptor.

14. Isochronous Transactions

A Full-speed USB Isochronous Transaction is one USB Frame's worth of either input or output. The USB 2.0 Specification limits the packet size for full-speed Isochronous Transfers to 1023 characters. The BUS frame number is defined as the number of 1 ms frame times that have passed since the bus was reset and is often (at least the lower 16 bits) maintained by hardware. Any given transaction is ‘scheduled’ to start in a given frame.

Groups of consecutive transactions may be presented to the Device Driver with a single starting frame number and a contiguous buffer.

These groups are in turn packaged into messages to the NHCI where the NHCI message data payload is packed as full as it can be to minimize overhead. Each such set will receive a response but only the last one will be associated in the Driver with the client call.

15. Implementation Notes for Windows 2000/XP

The Windows 2000/XP software for communicating with the NHCI device consists of two WDM drivers.

The first driver (e.g., nhcienum.sys) is a TDI client that uses the TCP stack to communicate with the NHCI device. It acts as the bus enumerator for NHCI devices connected to the network. It creates the device objects for each detected NHCI device (i.e. NHCI_{—}00, NHCI_{—}01 . . . ). Multiple NHCI devices on a network is supported. Each device object represents a separate USB host controller. Therefore, if the NHCI hardware contains two host controllers, two device objects will be created even though there is physically one NHCI box. The NHCI bus enumerator driver (e.g., nhcienum.sys) also abstracts the TCP details from the NHCI USB stack driver that is loaded above it. This driver is installed as “Root\NHCI_ENUM” and is loaded at boot time.

The second driver (e.g., nhciusb.sys) is the NHCI USB stack driver. It is loaded to manage NHCI host controller device objects instantiated by the NHCI bus enumerator. It handles the application level communication with the NHCI device. It packages USB-client requests into USB transactions which are sent to the NHCI device. The NHCI USB stack driver manages device PnP locally for USB child devices that are attached and removed from the NHCI device. One exception is hubs which are managed by the NHCI firmware and are not instantiated locally. The NHCI USB stack driver creates device objects for each of the child USB devices. USB client driver matching is based on constructing Hardware ID's using the USB Vendor ID and Product ID. Compatible ID's are constructed using the USB Class, SubClass, and Protocol. These values are read from the USB Device Descriptor. To maintain compatibility with existing USB client drivers, all Hardware ID's and Compatible ID's use the same format as the Microsoft USB stack.

ID Format:

Hardware ID
USB\VID_xxxx&PID_xxxx
Compatible ID's
USB\Class_xx&SubClass_xx&Protocol_xx
USB\Class_xx&SubClass_xx
USB\Class_xx

The NHCI USB stack driver supports the Microsoft URB (USB Request Block) interface for communicating with USB client drivers. However, the stack does not support the USBD_RegisterHCFilter( ) function as exported from the USBDI.LIB. All other Buildxx macros from the USBDI.LIB will work with the NHCI USB stack driver.

16. Implementation Notes for Mac OS X

The NHCI driver for Mac OS X is an IOKit type kernel extension (kext) which is loaded at boot time. It has IOKit driver matching properties:

IOProviderClass=IOResources

IOResourceMatch=IOBSD

The NHCI driver C++ object (called KeyspanNHCI) is a subclass of IOUSBController within the Apple USB protocol stack. As a subclass of IOUSBController, KeyspanNHCI implements a series of API calls called UIM Methods which define the interface between an abstracted USB Host Controller and the rest of the USB protocol stack.

The other main responsibility of the KeyspanNHCI driver object is to implement an abstraction of the USB Root Hub. In the Mac OS X architecture this is done by emulating the actual USB Hub hardware so that the USB Hub class driver can communicate with either a real USB Hub on the bus or the emulated Root Hub inside the KeyspanNHCI layer without knowing the difference. This is accomplished in the KeyspanNHCI object by intercepting messages addressed to the root hub and providing software emulated responses to those messages. These include standard USB Device Requests such as “Set Address” and “Get Descriptor” and the normal status Interrupt Endpoint of a USB Hub.

KeyspanNHCI implements its IP interface functions by using Mach Kernel threads and the Mac OS X BSD kernel socket library. The KeyspanNHCI object maintains one kernel thread for every separate NHCI device it is in communication with and one for the NHCI UDP broadcast/status port.

In Apple's USB implementation, one instance of the Host Controller Driver is expected for every separate physical USB bus. This is required to keep USB addresses and bandwidth allocation straight. Accordingly a separate instance of the KeyspanNHCI driver object is created for every separate physical USB bus within every separate NHCI device. The Keyspan NHCI-4 device, for example, includes two USB busses. [end section 16]

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing an Ethernet interface, it should be understood that other interfaces or devices having an equivalent function or capability, whether or not listed herein, may be substituted as appropriate for a type of network utilized by other embodiments of the present invention. Furthermore, the inventor recognizes and hereby declares that newly developed technologies not now known may also be substituted for the described parts and still not depart from the scope of the present invention. All other described items, including, but not limited to microprocessors, ports, drivers, servers, etc should also be consider in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Data used by the software may be retrieved from different sources (local or remote) and either permanently or temporarily stored (before, during, or after any processing) by utilizing any of text files, delimited files, database(s), or other storage techniques. Ultimately, such computer readable media further includes software for performing the present invention, as described above.

Included in the programming (software) of the general/specialized computer or microprocessor are software modules for implementing the teachings of the present invention, including, but not limited to, capturing communications from an application, packaging communications for transfer over a network, unpacking network communications and preparing data and/or commands contained therein for delivery to a USB device; sending data captured from a USB device to a computer hosting application software communicating with the USB device; setting up an operating system or other host parameters to divert communications to a network path; directing diverted communications to a remote USB host controller; broadcasting and/or sending announcements of devices attached to a remote host controller; and implementing security for access to devices connected to remote host controller according to the processes of the present invention.

Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A stand alone host controller, comprising:
a network interface;
a bus and at least one external port coupled to the bus; and
a processor coupled to the bus and the network interface and configured to process communications passed between the network interface and the bus.

2. The host controller according the claim 1, wherein the bus is a Universal Serial Bus (USB), the external port is a USB port, the communications are USB device related communications.

3. The host controller according the claim 1, wherein the network interface is at least one of an Ethernet port, a Wi-Fi or other wireless connection, LAN connection, and an internal interface to another system that provides network connection services.

4. The host controller according to claim 1, wherein:
the processor is further configured to implement USB 10.2 Host Controller requirements, receive USB formatted messages from the bus, prepare USB related communications from the received USB formatted messages, and place the USB related communications on the network interface.

5. The host controller according to claim 2, wherein:
the processor is configured to operate
an IP stack configured to work in conjunction with the communications being received and sent via the network interface,
a transaction server coupled to the IP stack and configured to process a set of messages passed to/from the IP stack and from/to the bus, and
a bus driver configured to facilitate transfer of the data and commands between the bus and the transaction server.

6. The host controller according to claim 5, wherein the bus is a Universal Serial Bus (USB).

7. The stand alone USB host controller according to claim 5, wherein the set of messages comprise at least one of Logon/Logoff, attach/detach, reset endpoint, and data transaction messages.

8. A method of operating a host computer, comprising the steps of:
identifying placement of a remote host controller on a network;
registering the remote host controller with the host computer; and
registering the host computer with the remote host controller.

9. The method according to claim 8, wherein said step of identifying comprises receiving a broadcast message regarding placement of the remote host controller on the network.

10. The method according to claim 8, wherein said step of identifying, comprises communicating with a well known port to receive information regarding placement of the remote host controller on the network.

11. The method according to claim 8, wherein said step of registering the host controller comprises setting parameters within the host computer to trigger recognition and processing of messages received from the host controller.

12. The method according to claim 8, wherein said step of registering the host computer comprises sending a registration request containing host computer identification information to the remote host controller.

13. The method according to claim 12, wherein said registration request includes security information to establish a trusted registration with the remote host controller.

14. The method according to claim 13, wherein said trusted registration is established by,
receiving an encoded password;
decoding the encoded password;
validating the decoded password; and
responding to the host computer positively or negatively based on the validation.

15. The method according to claim 14, wherein said step of validating comprises comparing the decoded password to a list of valid passwords.

16. The method according to claim 8, further comprising the steps of:
receiving a device message from the remote host controller with an identification of a device attached to the remote host controller; and
registering the device attached to the remote host controller with an operating system of the host computer.

17. The method according to claim 16, wherein:
the method is embodied in a set of computer instructions stored on a computer readable media;
the computer instructions, when loaded into a computer, cause the computer to perform the steps of the method.

18. The method according to claim 16, wherein the device is attached to the remote host controller via a Universal Serial Bus (USB).

19. The method according to claim 11, wherein said parameters include routing parameters for forwarding messages received by the host computer to a processing unit in the host computer configured to process host controller related messages.

20. The method according to claim 19, wherein said processing unit comprises a remote stand alone host controller driver installed in the host computer.

21. A method, comprising the steps of:
listening, with a host computer to a well known UDP port for broadcast host controller identification messages;
retrieving a TCP port # and a sending IP address of the remote host from a message broadcast from the well known UDP port;
establishing a TCP session with the remote host using the TCP port # and IP address.

22. The method according to claim 21, wherein the broadcast host message comprises all the information needed to set up a TCP session with the remote host controller.

23. The method according to claim 22, wherein said information comprises information needed to establish a “connection” with at least one USB device attached to the remote host controller.

24. The method according to claim 21, wherein:
the remote host is a standalone host controller and the sending IP address and TCP port # identify a transaction server of the stand alone remote host controller.

25. The method according to claim 24, wherein:
the stand alone host controller comprises a USB port; and
the stand alone host controller is configured to administer sharing of a USB device attached to the USB port with a plurality of host computers simultaneously coupled to the remote host via TCP session established with the TCP port # and sending IP address.

26. The method according to claim 25, wherein the stand alone host controller is configured to issue a USB detach message only to host computers that attempt to communicate with a USB device if the USB device is already communicating with another remote host.

27. A method of operating a remote host device, comprising the steps of:
detecting connection of a network to the remote host device; and
broadcasting a message on the network identifying presence of the remote host including an identification of the remote host.

28. The method according to claim 27, wherein said message identifying presence comprises security information for establishing a trusted connection.

29. The method according to claim 28, wherein said security information comprises a coded password

30. The method according to claim 27, further comprising the step of:
receiving a registration request from at least one host computer; and
registering at least one of the host computers with the remote host.

31. The method according to claim 30, further comprising the steps of:
detecting presence of a peripheral device attached to the remote host;
broadcasting an identification of the peripheral device to the registered host computers;
receiving at least one peripheral reply from the registered host computers; and
placing each registered host computer from which a peripheral reply is received on an access list for the peripheral device.

32. The method according to claim 31, wherein said step of broadcasting an identification comprises broadcasting an identification of the peripheral device and a list of devices previously attached to the remote host device to the registered host computers.

33. The method according to claim 31, further comprising the steps of:
receiving an access request from an access list registered host computer; and
establishing a connection between the peripheral device and the requesting host computer.

34. The method according to claim 33, further comprising the step of:
locking out other registered host computers from access to the peripheral devices for a duration of the connection.

35. The method according to claim 33, wherein said step of establishing a connection comprises administering communications between the requesting host computer and the attached peripheral.

36. The method according to claim 34, wherein said step of locking out other registered hosts comprises sending a detach message to the host computer if another host computer has communicated with the peripheral device within a predetermined time period of receipt of the communication request.

37. The method according to claim 33, further comprising the step of coordinating communications between the host computer and the peripheral device.

38. The method according to claim 37, wherein said step of coordinating communications comprises:
receiving a communication request from the host computer and placing the communication request on a USB bus attached to the peripheral device;
receiving communications from the peripheral device and placing them in a network formatted message and sending the network formatted message to the host computer; and
sending a detach message to the host computer if another host computer is communicating with the peripheral device at the time of receipt of the communication request.

39. The method according to claim 27, wherein the remote host device is a network attached device configurable to administer communications between host computers coupled to the remote host device via a network and USB peripheral devices directly attached to the remote host device.

40. A method of operating a remote host, comprising the steps of:
detecting attachment of a peripheral device to the remote host; and
narrowcasting a message over a network to a predetermined set of host devices announcing the detection of the peripheral device.

41. The method according to claim 40, further comprising the step of:
registering the attached peripheral device with at least one of the host devices in a manner such that the attached peripheral is accessible to applications running on the host device.

42. The method according to claim 40, wherein:
said step of detecting comprises sensing attachment of the peripheral device and identifying the peripheral device; and
said step of broadcasting a message comprises broadcasting an identification of the peripheral device and an identification of the remote host to the predetermined set of host devices.

43. The method according to claim 42, wherein:
the method is embodied in a set of computer instructions stored on a computer readable media;
the computer instructions, when loaded into a computer, cause the computer to perform the steps of the method.

44. The method according to claim 40, wherein the remote host is a USB stand alone host controller.

45. A stand alone host controller, comprising:
a network port;
at least one USB port; and
a transaction server, comprising,
a login thread configured to accept login requests received over the network port from a plurality of individual host computers, wherein the login thread verifies a password, and upon verification of the password, sends a login response to the successfully logged in host computer that includes a list of all devices attached to the at least one USB port, and
an operational thread configured to process messages between a successfully logged in host computer and one of the attached devices selected by the logged in host computer.

46. The stand alone host controller according to claim 45, wherein the attached devices are one of (1) under a default sharing model and (2) configured to a specific assignment to the IP address of the given client.

47. The stand alone host controller according to claim 45, further comprising a sharing mechanism that allows more than one host computer to register for access to a single one of the attached devices.

48. The stand alone host controller according to claim 47, further comprising a removal mechanism that prevents access by a host computer registered to access a specific attached device when the specific attached device is in use by another host computer also registered to access the specific attached device.

49. The stand alone host controller according to claim 48, wherein the removal mechanism is configured to send a USB detach message to a host computer that attempts to access an attached device when it is in use by another host computer.

50. A stand alone USB host controller, comprising:
at least one USB port;
a network port; and
a transaction server configured to register a device attached to the USB ports to a plurality of host computers coupled to the network port via a network;
wherein the transaction server comprises a conflicts mechanism configured to send a USB detach message to a host computer that attempts to communicate with an attached device when it is in use with another host computer.

51. The stand alone host controller according to claim 50, wherein the transaction server maintains a device in use by a host computer when the host computer communicates with the device;

52. The stand alone host controller according to claim 50, wherein the transaction server maintains a device in use by a host computer when the host computer communicates with the device and for a predetermined time period after any communications.

53. The stand alone host controller according to claim 52, wherein the predetermined time period is approximately 3 seconds.

54. The stand alone host controller according to claim 50, wherein the transaction server is further configured to send a USB attach message to any host computers that attempted to communicate with an attached device while the attached device was in use by another host computer after the other host computer stops using the attached device.

55. The stand alone host controller according to claim 50, wherein the USB attach message is sent after a predetermined time-out period following non-use of the attached device by the other host computer.

56. A computer readable media having a set of instruction stored thereon, that, when loaded into a processing device of a stand alone host controller, cause the stand alone host controller to perform the steps of:
receiving USB messages packaged as a network message and received on a network port of the stand alone host controller; and
administering the USB messages to a selected USB device attached to the stand alone host controller.

57. The computer readable media according to claim 56, wherein:
the remote stand alone host controller is configured to share the USB device between a plurality of Host computers attached to the network; and
said steps include an arbitration step that only allows administering of USB messages from a single one of the plurality of Host computers in any given time frame.

58. A computer readable media having a set of instruction stored thereon, that, when loaded into a processing device of a stand alone host controller, cause the stand alone host controller to perform the steps of:
registering a plurality of host computers;
sending a list of devices attached to the standalone host controller to each of the registered host computers; and
coordinating communications between each of the registered host computers and attached devices selected by the host computers.

59. The computer readable media according to claim 58, wherein said instructions further cause the stand alone host controller to perform the steps of:
sending a detach message to a host computer that attempts to communicate with an attached device being used by another of the host computers.

60. The computer readable media according to claim 58, wherein:
the host computers are coupled to the stand alone host controller via a network;
each of the attached devices are USB devices; and
said detach message is sent to the host computer if it attempts to communicate with an attached device in use or having been in use by another of the host computers within a predetermined time period.

61. A method, comprising the steps of:
receiving data from a USB stack on a host computer for a USB device logically installed on the host computer but physically installed on a remote stand alone host controller;
appending a header for the remote stand alone host controller onto the received data;
sending the received data and header to the remote stand alone host controller via a network.

62. The method according to claim 61, wherein said step of receiving occurs when the USB stack passes the data to a device driver for the remote stand alone host controller.

63. The method according to claim 61, wherein said network is an 802.11 network.

64. The method according to claim 61, wherein said network is an Ethernet network.

65. The method according to claim 61, wherein the remote stand alone host controller is configured to share the USB device between a plurality of Host computers attached to the network.

66. The method according to claim 61, wherein said method is embodied in a set of computer readable instructions, when loaded into a computer and used in combination with an application that sends the data to the USB device, cause the computer to perform the steps of said method.

67. A device driver, comprising:
a send data manager, comprising,
a capture mechanism configured to capture Application data associated with a USB device logically registered on a Host computer and physically located on a remote host controller,
a header mechanism configured to append a header identifying the USB device, and
a forwarding mechanism configured to forward the captured application data and appended header to a network stack.

68. The device driver according to claim 67, further comprising a mapping device configured to maintain a map between a local USB protocol stack and device information exchanged with the remote host controller.

69. The device driver according to claim 67, wherein said map comprises a USB bus address assigned by the NHCI and an address assigned by a local USB stack of the Host.

70. The device driver according to claim 68, wherein said map comprises routing information utilized by the header mechanism to append a header that identifies the USB device.

71. The device driver according to claim 67, wherein the device driver further comprises a receive data manager configured to receive data packages from an NHCI device and forward them to a local USB stack of the Host based on the map.

72. The device driver according to claim 67, wherein the remote host controller is configured to share the USB device between a plurality of Host computers attached to the network.

73. A data package, comprising:
application data associated with a USB device logically registered on a Host computer but physically located on a remote host controller; and
remote host controller header data prepended to the application data and identifying the USB device.

74. The data package according to claim 73, wherein said data package is constructed by a device driver using data received from a USB stack.

75. The data package according to claim 74, further comprising a device driver configured to send the data package over an attached network to the remote host controller.

76. The data package according to claim 73, wherein the remote stand alone host controller is configured to share the USB device between a plurality of Host computers attached to the network.

77. A data encapsulation scheme for use in a system for passing USB data from an application on a host computer to a USB device attached to a host controller coupled to the host computer via a network, the data encapsulation scheme comprising:
a USB data packet to be delivered to a specific USB device;
a first set of header data attached to the USB data packet that identifies the specific USB device; and
a second set of header data attached to the first set of header data that comprises network routing information corresponding to the host controller to which the specific USB device is attached.

78. A computer readable media having a set of computer readable instructions stored thereon, that, when loaded into a computer, cause the computer to produce the data encapsulation scheme according to claim 77.

79. The data encapsulation scheme according to claim 77, wherein said first set of header data is produced via a device driver of the host computer hierarchically located between a USB stack and an IP stack of the host computer.

80. The data encapsulation scheme according to claim 77, wherein:
the host controller is configured to administer sharing of a plurality of attached USB devices between a plurality of host computers; and
the sharing is in compliance with version 2.0 of the Universal Serial Bus (USB) Specification.
